(19) United States
(12) Patent Application Publication
(10) Pub. No.: US 2011/0069050 A1
(43) Pub. Date: Mar. 24, 2011

(54) Display system

(75) Inventors: James Brian Sirmon, Twickenham (GB); Anthony James Cole, Stoke Gifford (GB)

(73) Assignee: LITELOGIC IP LIMITED, London (GB)

(21) Appl. No.: 12/654,521

(22) Filed: Dec. 22, 2009

(30) Foreign Application Priority Data
Sep. 18, 2009 (GB) GB 0916404.7

(51) Int. Cl. G06F 3/038; G02F 1/13357

(52) U.S. Cl. 345/207; 362/97.1

(57) ABSTRACT

A display panel comprises a plurality of display printed circuit boards ‘PCB’ each of which has a plurality of light sources; and at least one bus bar; wherein the bus bar is electrically and physically connected each of the PCBs such that the plurality of PCBs are coupled together and held in registration with one another.

This invention relates to a display system, and in particular to improvements to a display system mounted on a vehicle, provision of power to the display system, and to the contrast ratio of the display system.

Display systems of the type in which a printed circuit board (PCB) is populated with light emitting diodes (LEDs) are well known. The LEDs are generally laid out on a constant pitch and can be individually controlled to emit light of a desired colour so as to create a desired static or moving image. Large display systems are generally created by providing a plurality of such PCBs adjacent to each other.

There are various problems with this type of display system. Firstly, the registration of the individual PCBs making up a large display is critical. It has been found that even a small error (e.g. 1 mm) in registration between adjacent PCBs can be detected by viewers and significantly affects the quality of the image created.

Secondly, when multiple PCBs are laid out to make a large display, it can be extremely complicated to couple power and video signals to each of the PCBs as separate cables must be run to each one. This is exacerbated when the display must be installed in a confined environment, and indeed in some circumstances may become impossible.

Another problem is encountered when the display systems are used outside. In such applications, the incident light from the sun can easily overpower the emitted light from the LEDs, rendering the image created by the display system invisible. Furthermore, in outdoor environments it is quite usual for viewers to approach the display system from directions other than the normal intended viewing axis (i.e. the viewers may be a long way off-axis). There is therefore a need to enhance the viewing angle of this type of display system as much as possible. These two problems affect both display systems comprising single and multiple PCBs.

Further problems are encountered if it is attempted to mount the display system on a vehicle, particularly overheating of the display.

In accordance with a first aspect of the invention a display panel comprises: a plurality of display printed circuit boards ‘PCB’ each of which has a plurality of light sources; and at least one bus bar; wherein the bus bar is electrically and physically connected each of the PCBs such that the plurality of PCBs are coupled together and held in registration with one another.

In accordance with a second aspect of the invention a method of operating a display panel comprising a plurality of light sources, the method comprising: sensing an ambient light level; and setting the brightness of the light sources to provide a desired contrast value based upon the sensed ambient light level; wherein the rate of change of the brightness of the light sources has a predetermined maximum value.

In accordance with a third aspect of the invention a display panel according to the first aspect, further comprises a control means adapted to cause the display panel to carry out the method according to the second aspect.

An embodiment of the invention will now be described with reference to the accompanying figures in which:

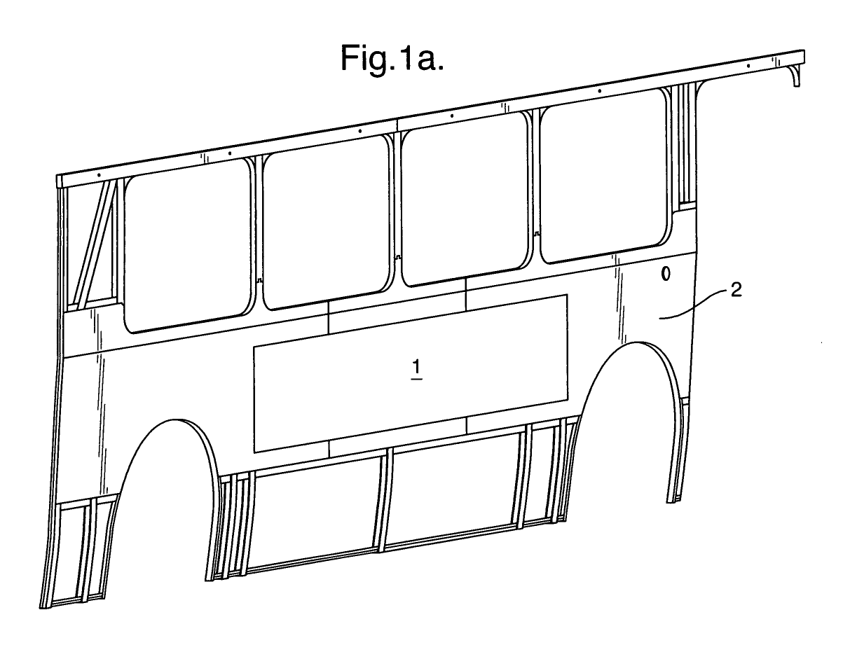

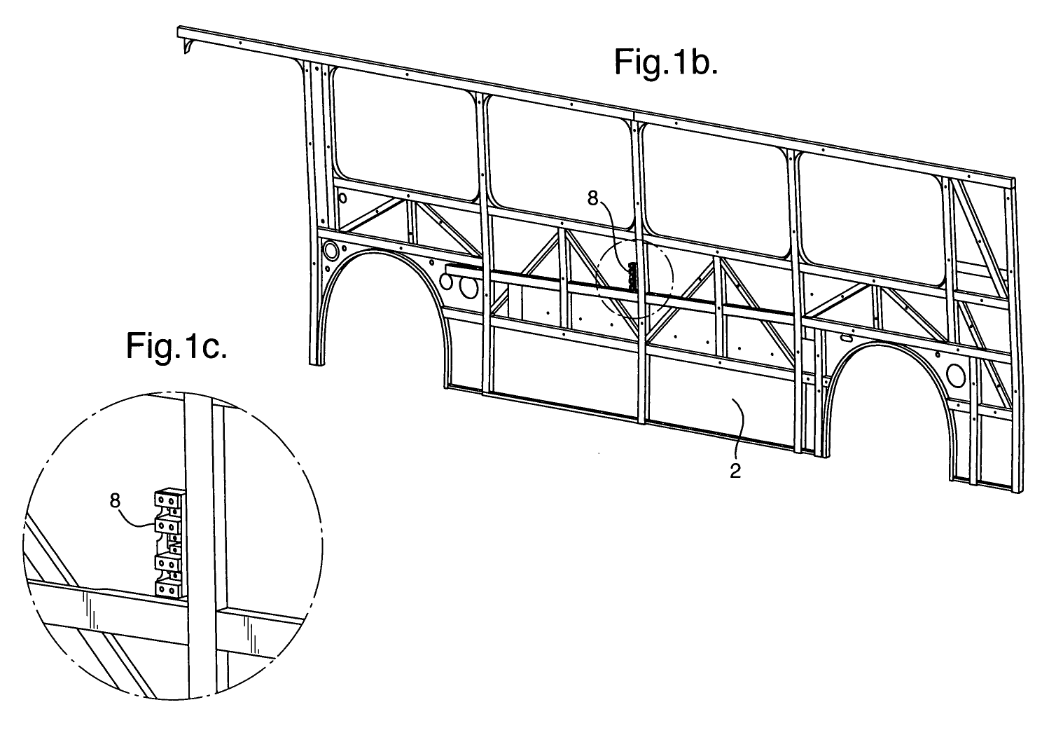

FIG. 1a shows an external view of a vehicle side mounting a display panel according to the invention;

FIG. 1b shows an external view of the vehicle side of FIG. 1;

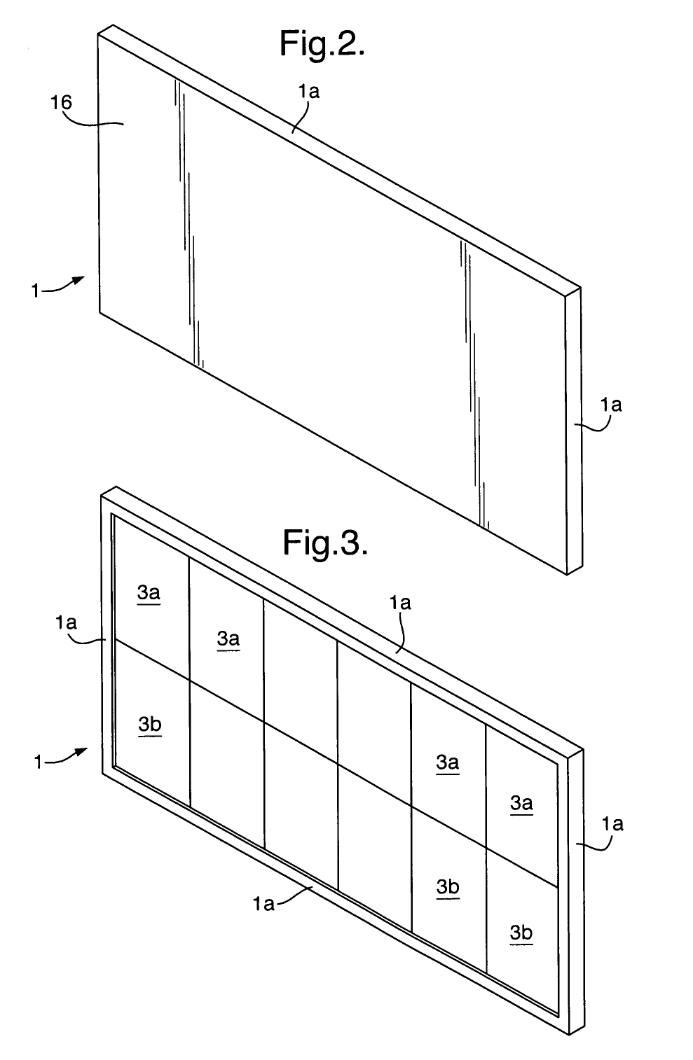

FIG. 1c shows an enlarged view of a part of FIG. 2;

FIG. 2 shows the display panel;

FIG. 3 shows the display panel with the front cover removed;

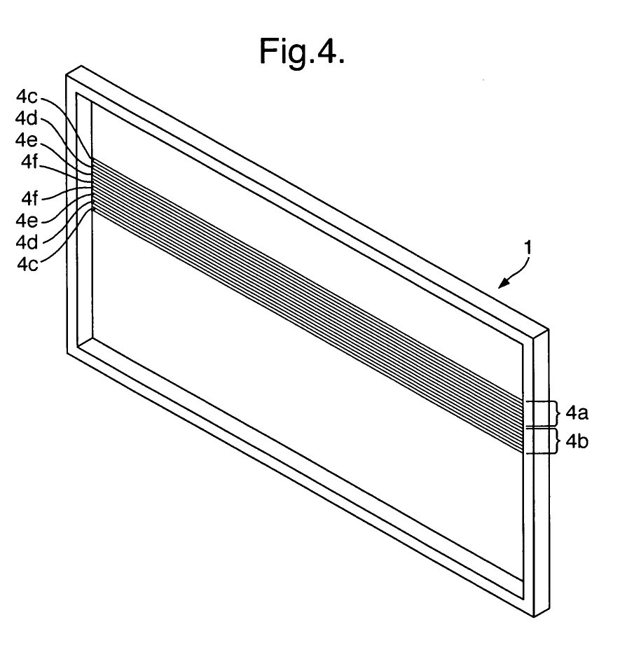

FIG. 4 shows the arrangement of the bus bars within the display panel;

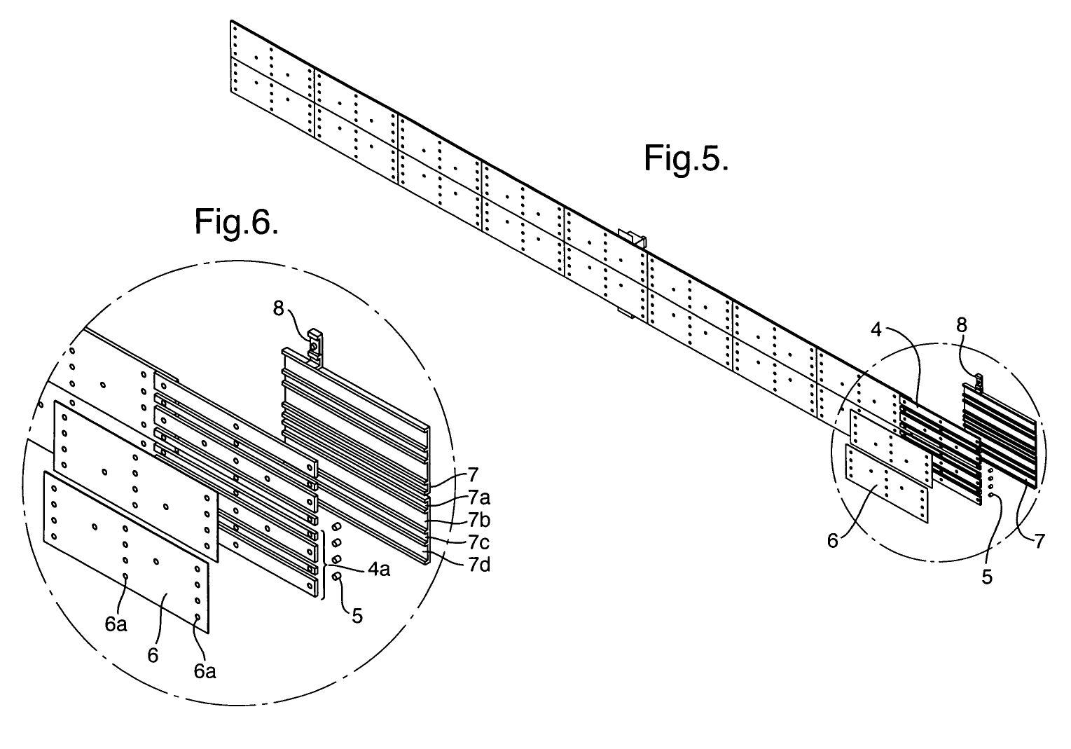

FIG. 5 shows structure associated with the bus bars;

FIG. 6 shows a part of the structure of FIG. 5 in more detail;

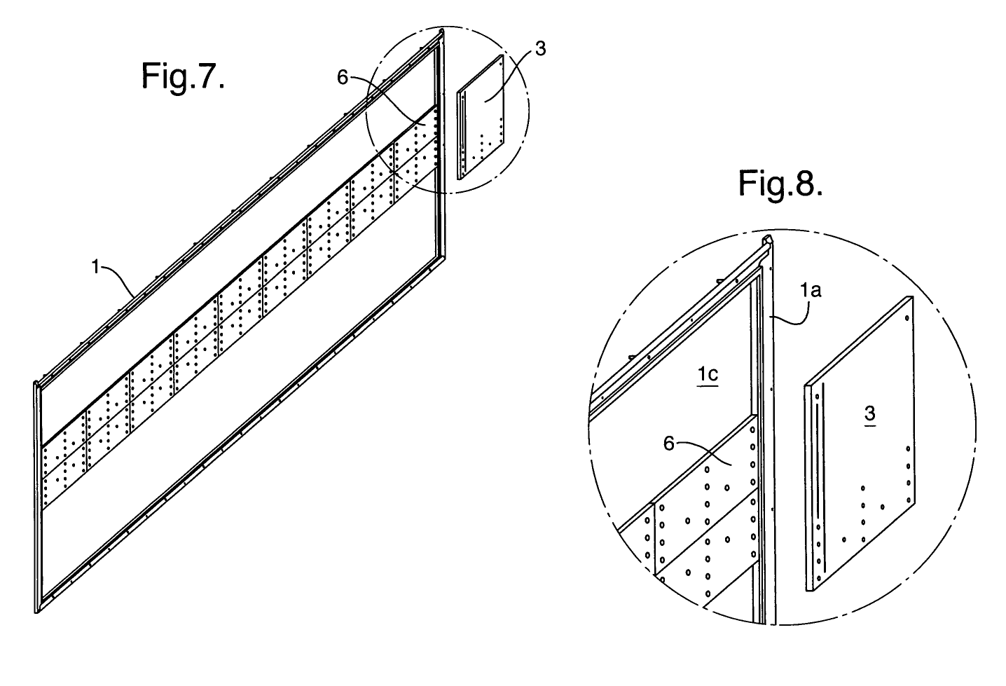

FIG. 7 shows the display panel with both the front cover and the PCBs removed;

FIG. 8 shows a part of FIG. 7 in more detail; and

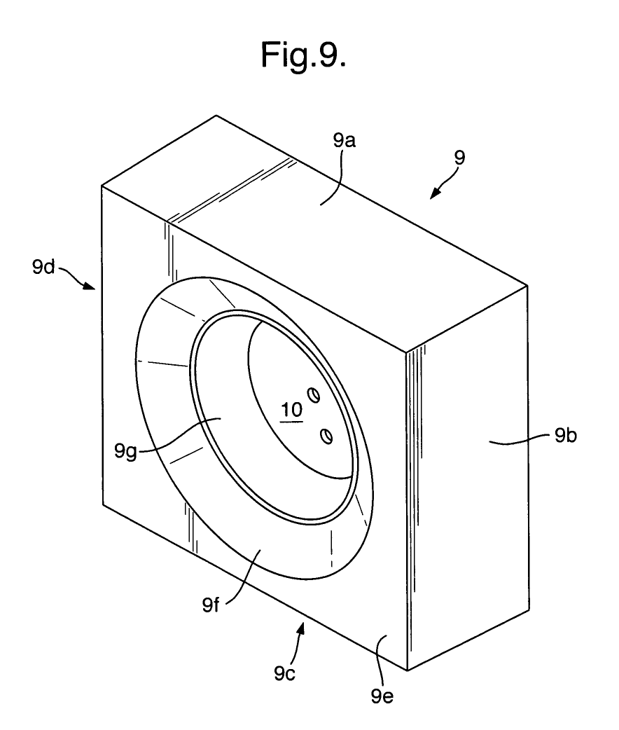

FIG. 9 shows a cap for an LED.

FIG. 1a shows an exterior view of a display panel 1 according to an embodiment of the present invention mounted on an exterior of a vehicle. In the illustrated example the vehicle is a coach or bus 2.

The display panel 1 is rectangular and is mounted overlying a rectangular area of the side of the bus 2. From the exterior view it might appear to be relatively simple to select a suitable region of the side of the bus 2, attach the flat rectangular display 1 to the flat side surface of the bus 2, and pass power cables through the side of the bus 2 to provide power to the display 1 from the bus battery. However, finding suitable locations in the bus side structure for attachment of the display system, for example using bolts, and for passing the power cables through the bus side is not a simple matter.

This can be understood from FIG. 1b, which shows an interior view of a typical bus side showing the side structure. This complex structure is of course usually concealed from view. The complex side structure means that there are usually only a few locations suitable for securing a display panel, and only a few points where power cables can be passed through the bus side, particularly because it is desirable to avoid placing cables or other components inside the bus 2 in locations where they could inconvenience passengers.

In order to minimize any impact on the dimensions and operation of the bus 2 it is highly desirable to make the display 1 as thin as possible. The display panel 1 projects outwardly from the outer surface of the bus 2 so that there is a risk of collision with objects or vehicles damaging the display panel 1. Further, it is possible that the display panel 1 could obscure some parts of the drivers vision. Clearly, the thinner the panel 1, the lower the risk that a collision or obscurement of vision will occur. Further, the thicker the panel 1, and thus the further the panel 1 projects from the surface, the greater the risk that it will be necessary to modify the way the bus 2 is driven in order to allow for the presence of the display panel 1. It is of course most undesirable that a driver should have to change his driving behaviour based on the presence or absence of a display panel 1 on the side of the bus 2.

It would be possible to reduce or even eliminate the amount of projection of the display panel 1 by locating the display panel 1 in a recess in the side of the bus 2. However, this is clearly impractical if the display panel 1 is to be fitted to an already existing bus 2. Further, it would be extremely costly to modify the bus design to include such a recess, and would undesirably limit the bus 2 to a specific size of display panel. In any event, even if the display panel 1 is located in a recess it is still desirable to make the display panel 1 as thin as possible in order to minimise the required recess depth.

In practice, when the display panel 1 is thin the problem arises that the display panel 1 has a relatively low thermal; mass so that it can easily overheat. Further, the thinness of the panel makes it physically difficult to cool because of the lack of space for cooling air channels and the like. Accordingly, when designing a thin display panel suitable for use on the exterior of a vehicle it is desirable to reduce the amount of heat generated inside the display panel 1 as far as possible.

Overheating of the display panel 1 may not only be a question of whether the temperature of the display panel 1 becomes so high that components of the display panel 1 fail. When the display panel is located in an accessible location, and particularly when it is mounted on a vehicle it will usually be required that the temperature of the display panel does not become high enough to cause injury to persons contacting the display panel 1.

A general view of a display panel 1 suitable for mounting on a vehicle according to an embodiment of the present invention is shown in FIG. 2.

The display panel 1 is rectangular and is formed by four side pieces 1a, a rectangular transparent polycarbonate front cover 1b, and a back surface 1c. The side pieces 1a can typically be extruded from a plastic material. Typically, the side pieces 1a are extruded so as to provide a recess (not shown) on the underside around the whole inside edge of the side pieces when they are assembled. This recess receives a back surface 1c, which may be secured to the side pieces 1a. The polycarbonate front cover 1b provides some environmental protection whilst allowing the display to remain clearly visible. The polycarbonate front cover 1b is typically provided with an infra-red reflective coating on its outer surface. This prevents the display from absorbing too much infrared radiation when placed in direct sunlight, which can otherwise lead to a dramatic rise in temperature of the display.

The display panel 1 is sealed to prevent water and other environmental contaminants from entering the display panel 1. Ensuring the display panel is sealed against water is particularly important when the display panel is used on a vehicle because vibration and flexing of the vehicle side or physical impacts on the cover 1b can result on a bellows effect producing a partial vacuum within the display panel 1 which can act, in wet conditions, to suck water into the display panel 1 through any leaks in the seal. The cover 1b is preferably connected to one of the side pieces 1a by a hinge so that the cover 1b can be opened to allow access to the interior of the display panel 1, for example to allow servicing or repair.

The use of a back surface 1c is not essential, but is preferred, particularly when the display panel 1 is to be mounted on a vehicle such as a bus 2. In practice the side, or other surfaces, of a vehicle vibrate and flex in use so that it will be difficult to form a durable and reliable seal between the side pieces 1a of the display panel 1 and the side of the vehicle. Further, including a back surface 1c allows the electronic components of the display panel 1 to be entirely contained within the display panel 1. In the event of a fire within the display panel 1 such containment can ensure that the fire is isolated within the display panel 1 and does not enter and effect the vehicle.

Although the use of polycarbonate to form the cover 1b is not essential, this is preferred because of its strength and scratch resistance.

The sealing of the display panel 1 and the use of a scratch resistant transparent cover 1b are desirable to prevent accidental or environmental damage to the display panel 1 when used outdoors, and particularly when mounted on the outside of a vehicle. Further, these properties are particularly desirable when the display panel 1 is mounted on a bus 2 because buses are usually regularly washed using industrial vehicle washing equipment such as high pressure washer jets, rotating brushes and degreasing solutions, which are potentially extremely destructive to electronic and optical components.

Referring to FIG. 3, a display panel 1 is shown with the cover 1b removed. The display surface of the display is formed by a plurality of display PCBs 3 arranged adjacent to one another with a predetermined spacing to form a single display surface. In the illustrated embodiment twelve display PCBs 3 are arranged in an array having two rows of PCBs 3, an upper row of PCBs 3a and a lower row of PCBs 3b, and six columns. As will be explained further below, the PCBs 3 are held in a spaced relationship with respect to each other so that the gap between each PCB 3 is accurately set.

Each of the display PCBs 3 has a front face populated by a plurality of LEDs, each of which represents a pixel of the display panel 1. Control and power supply circuitry for the LEDs is mounted on the rear faces of the PCBs 3. The spacing between the LEDs on the front face of each PCB 3 is constant, and the positioning of the LEDs around the periphery of each PCB 3 is set so that the pixel pitch is maintained across the gaps between the PCBs 3. This ensures that the image created has a uniform, constant pixel pitch across the entire display surface as well as ensuring perfect registration between the PCBs 3.

In considering the problem of ensuring accurate registration between the PCBs 3 it might be expected that the problem could be avoided by using larger PCBs. However, this is not a practical solution. As explained above, the side, or other surfaces, of a vehicle vibrate and flex in use and this vibration and flexing will cause large PCBs to fail as the resulting stresses on the PCB either lead to physical failure of the PCB itself or electrical failure of the circuits on the PCB.

The LEDs are preferably tricolour LEDs (such as the LP6-NPP1-01-N1 from Cotco Luminant Device (Huizhou) Limited), each of which is effectively a combination of discrete red, green and blue LEDs in the same device. The use of tricolour LEDs allows the display panel 1 to display a full colour image with a minimum number of physically discrete LEDs, allowing the volume required by the display components, and thus the thickness of the display panel, to be minimised.

The LEDs are preferably surface mounted on the front face of each PCB 3. This allows the overall thickness of a PCB 3 to be reduced, compared to other mounting techniques such as through-hole mounting, and so allows the thickness of the display panel 1 to be minimised. Further, surface mounting of the LEDs simplifies design of a PCB 3 because the entire rear surface of the PCB 3 is available for control and power circuits.

The PCBs 3 are supported and supplied with electrical power by bus bars 4. Preferably, the bus bars 4 are copper. As shown in FIG. 4 two bus bar sets 4a and 4b, each comprising four parallel bus bars 4c to 4f, run across the full width of the rear of the display panel 1. Comparing FIGS. 3 and 4, the two bus bar sets 4a and 4b run on either side of the gap between the upper rows of PCBs 3a and the lower row of PCBs 3b so that the upper row of PCBs 3a are supported and supplied with electrical power by the upper bus bar set 4a and the lower row of PCBs 3b are supported and supplied with electrical power by the lower bus bar set 4b.

Each bus bar set 4a and 4b comprises four bus bars 4c to 4f. The bus bars 4c to 4f of each set each carry a different supply voltage and the bus bar 4f of each set is a common 0V return rail for each of these supplies. Between them, the bus bars of each set carry two 3.3V supplies and a 4.5V supply. One 3.3V supply and the 4.5V supply are used to provide power to the LEDs on the PCBs 3. Two supply voltages are used because the red LEDs operate at a lower forward voltage than the green and blue LEDs. The red LEDs operate at a forward voltage of around 2.8V derived from the 3.3V supply, whereas the blue and green LEDs operate at a forward voltage of around 4.1V derived from the 4.5V supply. The PCBs 3 carry LED driver circuitry, based on the TLC5941 LED Driver from Texas Instruments, which can selectively provide forward current to each LED at the correct forward voltage. The other 3.3V supply is used to power the driver circuitry on the PCBs.

By supplying different supply voltages to the LEDs in this way, the efficiency of the display system with respect to prior art systems may be dramatically increased. In prior art systems, all the LEDs are supplied with power at a common voltage, typically 5V, through respective bias resistors which lower the voltage across the LEDs to the forward voltage when the forward current is flowing. Not only does this approach require a vast quantity of resistors to be fitted to the display PCBs, but the bias resistors also dissipate a large amount of power in the form of heat as the forward current flows through them. Further, the use of bus bars to carry the high currents inherent in a display system using large numbers of LEDs minimises the voltage drop and heat produced within the display panel 1 due to resistive heating. Thus, by providing different supply voltages to the LEDs using the different bus bars the power consumption of the display panel 1 and the amount of heat generated inside the display panel 1 in operation are both can both be reduced.

Preferably the two bus bar sets 4a and 4b have their component bus bars 4c to 4f arranged symmetrically about the gap between the upper row of PCBs 3a and the lower row of PCBs 3b. This allows all of the PCBs 3 to have the same layout of power circuitry and connections with the orientation of the PCBs 3a of the upper row and the PCBs 3b of the lower row simply being reversed. This simplifies design and manufacture of the PCBs.

Although the PCBs 3 of the upper row of PCBs 3a and the lower row of PCBs 3b may have the same length, that is, the same extent perpendicular to the bus bars 4, so that the gap between the upper row of PCBs 3a and the lower row of PCBs 3b runs along the centre of the display panel 1, this is not essential. In the illustrated example the PCBs 3b of the lower row are longer than the PCBs 3a of the upper row.

Having all of the PCBs 3 with the same length would provide the advantage that all of the PCBs 3 could be identical, simplifying manufacture of the PCBs 3 and assembly and maintenance of the display panel 1. However, for any selected pitch of LEDs each length of PCB 3 corresponds to a specific number of LEDs and in practice, because of the requirements of the control and power supply circuits to the LEDs, some lengths of PCB and corresponding numbers of LEDs can be made more efficiently than others. Accordingly, having PCBs 3 of different lengths in the upper and lower rows may sometimes be preferred.

Preferably all of the PCBs 3 have the same width, that is the same extent parallel to the bus bars 4.

The PCBs 3 are supported and registered by the bus bars 4 using through holes 4g drilled at predetermined positions along the length of each bus bar 4. Corresponding plated through holes 3a are provided in each PCB 3 so that the PCBs 3 can be electrically connected and physically secured to the bus bars 4 by passing bolts or studs 5 through the holes 4g in the bus bars 4 and the corresponding through holes 3a in the PCBs 3. Preferably the through holes 4g are arranged in a repeating symmetrical pattern so that all of the PCBs 3 can have the same layout of holes 3a with the orientation of the PCBs 3a of the upper row and the PCBs 3b of the lower row simply being reversed. This simplifies design and manufacture of the PCBs.

In order to prevent undesired electrical contact between the bus bars 4 and circuits on the rear faces of the PCBs 3 insulating spacer plates 6 are located between the PCBs 3 and the bus bars 4. The plates 6 have through holes 6a corresponding to the positions of the holes 4g in the bus bars 4 and the through holes 3a in the PCBs 3. Preferably the plates 6 are sized so that the extent of each plate 6 parallel to the bus bars 4 corresponds to the extent a single PCB 3.

In order to provide additional support for the bus bars 4 and ensure accurate positioning each bus bar set 4a and 4b is supported by a respective support member 7. Each support member 7 is secured to the structure of the display panel 4. Conveniently each support member 7 can be attached to the back surface 1c by a plurality of clips 8. Each support member 7 is formed of insulating material and extends across the full width of the display panel 1, forming four parallel flat sided channels 7a to 7d defined between outwardly extending walls. Each channel 7a to 7d is sized and spaced to retain and support a respective one of the bus bars 4c to 4f of a bus bar set 4a or 4b. The support members 7 support the copper bus bars 4 and prevent them from being bent or deformed, which could otherwise cause the PCBs 3 to be move out of their correct registration, degrading the displayed image. Further, the insulating walls of the support members 7 extending between the bus bars 4 helps to prevent the bus bars 4 contacting one another and short-circuiting, even in the event that the display panel 1 is badly damaged.

When the spacers 6 are located between the PCBs 3 and the bus bars 4 the spacers 6 will rest on the walls 7 of the support members.

Preferably the spacer plates 6 and the support members 7 can be extruded from a plastic material.

The use of support members 7 is preferred, particularly when the bus bars 4 are copper, which is a relatively soft and ductile metal. Whether the support members 7 are required at all, or whether some other alternative support structure is required, will depend upon the materials and dimensions of the bus bars 4 and the expected loads to which they subjected in operation.

The PCBs 3 are thus held in a spaced relationship with respect to each other and registered with the gap between the PCBs 3 being defined entirely by the location of the through-holes 3a and the locations of the holes 4g in the bus bars 4. These can be very accurately controlled in manufacturing so that the registration of the PCBs 3 is cheaply and accurately set. Vibration and flexing of the display panel 1 is accommodated by bending of the bus bars 4 and relative movement of the PCBs 3 without damaging stress being applied to the individual PCBs 3.

This arrangement provides a truly scaleable solution to the problem of building display systems of different sizes because it allows small standard sized PCBs to be placed alongside as many others as are required whilst maintaining pixel registration. The only requirement is for a suitable number of bus bar sets to be provided in the display.

In the illustrated embodiment two bus bar sets are used forming a spine of the display with PCBs extending outward to either side of this spine. However any other number of bus bar sets could be used. For this reason it is preferred that the support members 7 and spacers 6 extend across only a single bus bar set in order to allow the same components to be used for displays with different numbers of bus bar sets.

Although the PCBs 3 are supported and registered by the bus bars 4, the PCBs 3 could be further supported if desired, for example by clips or supports attached to the side pieces 1a or back surface 1c.

The use of bus bars carrying appropriate supply voltages not only improves the efficiency and reduces heating of the display panel 1 but also allows the display system to occupy a much smaller volume. In fact, we have been able to make a display panel with a thickness of only 19 mm, which would simply be impossible using standard wiring looms as the current flowing in the 0V return can reach values as high as 900 A.

The use of bus bars also provides some further advantages.

The power connection to the bus bars can be made at any point along the bus bars. Accordingly, because the bus bars extend right across the display panel 1, the power connection to the display panel 1 can be made at any point across the display panel 1. Further, in the embodiment described above, although there are two rows of PCBs both of the sets of bus bars are grouped together side by side.

As a result, when the display panel 1 is to be mounted on a vehicle such as a bus 2, only a single power connection passing through the side of the bus 2 at a single position is required. Further, this single point power connection can be located at any point across the display panel wherever is most convenient in terms of the bus itself, for example to obtain the best support and routing of the power cables through the bus 2. This capacity to select a point anywhere across the display panel 1 for the power connection greatly simplifies finding suitable attachment and power connection locations on a vehicle. It would be impossible to do this with a conventional wiring loom without either custom designing the wire loom of the display panel for each specific model of vehicle or greatly increasing the thickness of the display panel.

This advantage is illustrated in FIGS. 1b and 1c where the single break through point has been selected based on the structure of the bus side so that the power connection 8 can be supported by structural members of the bus side.

Preferably any necessary data connections are also passed through the same single connection passing through the side of the bus. Unlike the high current power connections it is relatively simple to arrange for a data connection to be at any desired point. Having only a single connection passing through the side of the bus 2 helps ensure that if there is a fire in the display panel 1 the fire is isolated within the display panel 1 and does not enter and effect the bus 2.

Further, the bus bars 4 act as heat sinks for the PCBs 3. This slows heating of the PCBs 3 and prevents local overheating by distributing heat more evenly across the display panel.

Preferably, if it is desired to actively cool the display panel 1 this can be done by passing cooling air past the bus bars 4. The cooling air can travel through air channels defined around the bus bars 4 by the support members 7 and spacers 6. Together with the heat sink effect of the bus bars 4 this provides very effective cooling.

Conveniently, the cooling air can be taken from inside the bus 2 and vented to the outside. The is particularly effective if the bus I is air conditioned.

Preferably the LEDs used in the display panel 1 do not have lenses. In this specification, the term “lens” is used to refer to a transparent element associated with the LEDs, which may be either integral with or separate from the LEDs, which causes redirection of the light emitted by the LEDs. Such redirection may be caused by any one of a number of physical processes, including refraction, diffraction, collimation and diffusion.

The lenses used in LEDs come in many variants. Clear lenses have no tint and provide no diffusion of the light. They produce the most intense light output and narrowest viewing angle by refractively causing convergence of the beam. They are designed for applications that require very high intensity but need to appear colourless when the LED is off. Tinted lenses are similar but are used to indicate what the LED colour will be when turned on.

Diffusing lenses have tiny glass particles embedded in the lens. This spreads the light to a viewing angle of approximately +/−35 degrees from the central axis of the LED. These LEDs are often used for applications in which the LED protrudes through a hole in the front panel of electronic equipment.

Non-diffusing lenses that do not have glass particles in the lens produce a narrow viewing angle of +/−12 degrees from the central axis of the LED. They are often used in backlighting applications in which the LED is focused on a translucent window in the front of a panel.

It has been found that the lenses used in LEDs have the undesirable effect of reducing the viewing angle of the display systems dramatically. They are generally fitted to LEDs because it is generally perceived that it is better to provide a narrower, brighter beam from the LED to improve its contrast.

However, when an LED display system is used outdoors this is not necessarily the case as viewers can approach the display from all angles. Most display systems based on LEDs are deployed in situations where the audience is in a known viewing position. In contrast the display panel described herein is adapted specifically for use in environments where the audience may be in any position relative to the display system. For example, if the display panel is mounted on the side of a vehicle such as a bus the audience may be standing on a pavement alongside the bus but beneath the display or they may look at the display from a building at a level which may be above, below or the same as the level of the display. Furthermore, people may view the display as the vehicle approaches or moves away from them.

Furthermore, the use of LEDs without lenses allows tricolour surface mount LEDs to be used instead of discrete red, green and blue LEDs. In a tricolour LED, the red, green and blue elements are each provided slightly off the central axis of the LED. If they are placed behind a lens then the resultant red, green and blue images do not converge properly to form a combined full-colour image but instead all remain slightly off axis. Therefore, discrete red, green and blue LEDs had to be used in the past for colour displays. This solution therefore cuts the number of LEDs that need to be placed on a PCB by a factor of three.

Further, it is preferred that each of the LEDs is fitted with a cover.

A particular problem for exterior LED displays is ensuring that the contrast ratio of the displayed image is sufficiently high for good visibility when sunlight may be incident on the display. This problem will be encountered by a display panel mounted on a vehicle. The contrast can be increased by increasing the brightness of the LEDs, but this will undesirably increase both power consumption and heat generation in the display panel 1.

It has been realised by the applicant of the present application that the problem of insufficient contrast when an outdoor LED display is in sunlight arises in part because LEDs are traditionally white plastic or metallic so that they reflect incident sunlight well.

FIG. 9 show a cover 9 for a surface mount LED such as may be fitted to the PCBs discussed above. The cover 9 is injection moulded from a plastic material, and preferably a black plastic material. It comprises four side walls 9a to 9d and a top wall 9e. The top wall 9e has a bevelled section 9f with an aperture 9g at its centre. The bevelled section 9f mitigates the limiting effect that the wall thickness of top wall 9e might otherwise have on viewing angle.

The side walls 9a to 9d and the top wall 9f together define a recess which allows the cover to be placed over an LED 10. Two of the side walls 9a and 9c form an interference fit with the LED 10, thereby preventing the cover from falling off.

Within the recess, there are some ribs (not shown) which interdigitate with the legs LED 10 to ensure that the aperture 9g is aligned with the light emitting part of LED 10.

Without the cover, incident light is reflected by the body of the LED, which is typically white plastic or metallic. However, the cover obscures a large portion of the LED from view. Since the material from which the cover is made absorbs substantially all of the incident visible light falling on it, the light emitting portion of the LED, which is still visible through the aperture, is operating in conditions close to perfect to black body radiation. This dramatically enhances the contrast ratio.

The cover provides a very cheap way of enhancing the contrast ratio, and when used in conjunction with black PCBs a very effective, high contrast display PCB may be manufactured.

This combination of features improves the contrast ratio as well as the viewing angle and it has been found that the resulting display assembly may be viewed with excellent contrast characteristics over almost an entire hemisphere.

In practice is has been found that the use of black caps on the LEDs can reduce the required brightness to provide the necessary contrast by between 20% and 30%, which corresponds to a 50% reduction in power consumption and heat generation.

Vehicle mounted displays must be powered from the vehicle electrical system, generally through a DC/DC power converter. When a display panel 1 is mounted on a vehicle the power conversion required will depend upon the characteristics of the vehicle electrical system. However, in the present invention it is preferred to locate any necessary power converters in the vehicle, for example the bus 2, and not in the display panel 1 itself. The power converters can be placed anywhere convenient inside the bus, for example under the floor or inside a casing under a seat. Power converters will inevitably produce some heat, so placing the power converters outside the display panel 1 will further reduce the amount of heat generated within the display panel 1.

This also provides the further safety advantage that any high voltage components of the power converters are located inside the bus 2. Accordingly, even in the event of damage to the display screen 1 the maximum voltage which can possibly be exposed is the 5 volt power supply. There is no possibility of high voltage components being exposed outside the bus 2 and creating a risk of injury.

The display panel 1 must be controlled in order to display messages or images. The efficiency and safety of the display can be further improved, and the amount of heat generated by the display panel 1 reduced, by appropriate control methods.

A controller is a provided to control operation of the display panel 1 together with photo sensors to sense ambient light levels. Preferably the controller is adapted to continuously vary the brightness of the display in response to the sensed ambient light level to attempt to maintain a desired level of contrast by raising the brightness of the display panel 1 when the sensed ambient light level increases and vice versa. In order to prevent abrupt changes in brightness which could be noticed by observers the rate of change of brightness is preferably limited by the controller. It has been found that allowing a maximum rate of change of brightness of 1% per second allows reasonably rapid response to changes in ambient light level without the change being perceptible to observers. Limiting the maximum rate of change of brightness also prevents sudden decreases and then increases in brightness when ambient light levels drop temporarily, for example when a vehicle mounting the display panel 1 moves through a shadow.

In contrast to prior art vehicle mounted displays, which typically have only a bright “day” setting and a less bright “night” setting, such continuous variation of the display brightness allows power consumption and heat generation in the display panel to be reduced by continuously adapting the display brightness to match ambient light levels instead of continuously operating at a fixed brightness level bright enough for all circumstances.

Preferably changes in brightness are carried out at the LED drivers on each PCB 3. This can minimise loss of contrast when brightness is reduced.

Preferably the controller is also adapted to reduce brightness, and thus power consumption and heat generation in the display panel, in response to detection of high temperatures in any of the PCBs 3 or the power supply components, such as the power converters, or in response to a low level of charge in the vehicle batteries.

One possible control protocol is for light sensor reading to be sampled once a second, and averaged with the previous 29 samples. This averaged value is used to calculate the new screen brightness. The new screen brightness is set every second, so if the ambient brightness changes, the screen brightness will slowly change over 30 seconds, or longer if the light level has changed by more than 30% due to the maximum rate of change, to the new brightness. PCb temperature, power supply temperature and battery voltage also affect the brightness of the screen. These readings are mapped to a brightness value. In normal conditions this mapping maps to 100% brightness, but when each reading reaches a respective pre-determined value the associated brightness value linearly ramps down to 0% brightness. For example, with PCB temperature the average or maximum PCB temperature is used, when this value is below (say) 70 Deg C, the brightness associated with LED Board temperature is 100%, from 70 to (say) 85 Deg C this brightness linearly ramps down to 0% brightness, any temperature above 85 Deg C sets this brightness value to 0%.

There are two additional settings used, maximum and minimum brightness. So the actual screen brightness is calculated as follows: every second, take the minimum of the following brightnesses: Maximum brightness setting, Ambient Light calculated brightness, PCB Temperature calculated brightness and Power Supply Temperature calculated brightness. If this minimum brightness value is below the set minimum brightness value then the set minimum brightness value is used. This value is then averaged with the previous 29 values to obtain the actual value to set the screen brightness.

Preferably the controller is also adapted to shut down the operation of the display panel 1 if any problem occurs. For example the controller may shut the display panel 1 down in response to failure of any PCB 3, or high temperatures in any of the PCBs 3 or the power supply components, such as the power converters, which exceed predetermined safe levels, or in response to a level of charge in the vehicle batteries below a set minimum level. Further, the controller can be adapted to shut down the operation of the display panel 1 in response to detection of excessive humidity within the display panel 1, which may indicate water ingress.

The individual components of the display panel 1, for example the LED controller on each PCB, are adapted to carry out self checking and to shut down if any problem is detected. Preferably, the controller is also adapted to shut down the operation of the display panel 1 if any component shuts down in order to prevent the display panel 1 operating with only part of the display panel 1 functioning.

Preferably, if the control system for the display panel required any antennae, for example a communications antenna or a GPS antenna, these antennae are incorporated into the display panel.

The display panel is described above with reference to use on a bus. The display panel can also be used on other types of vehicle, for example commercial vehicles or passenger vehicles, and also in non-vehicle applications.

The display panel 1 could be provided in the form of a kit of parts.

The above description relates to exemplary embodiments of the invention. The skilled person will be able to envisage alternatives within the scope of the present invention as set out in the appended claims.

1. A display panel comprising: a plurality of display printed circuit boards ‘PCB’ each of which has a plurality of light sources; and at least one bus bar; wherein the bus bar is electrically and physically connected each of the PCBs such that the plurality of PCBs are coupled together and held in registration with one another.

2. The display panel according to claim 1, wherein light sources on each of the plurality of PCBs are supplied with power through the bus bar.

3. The display panel according to claim 1, comprising a plurality of bus bars each electrically and physically connected each of the PCBs.

4. The display panel according to claim 1, wherein each display PCB bears a first set of light sources adapted to emit light of a first colour and a second set of light sources adapted to emit light of a second colour, the first set of light sources being electrically coupled to a first one of the bus bars which is supplied with power at a first voltage, and the second set of light sources being electrically coupled to a second one of the bus bars which is supplied with power at a second voltage.

5. The display panel according to claim 4, wherein each display PCB bears control circuits, the control circuits being electrically coupled to a third one of the bus bars which is supplied with power at a third voltage.

6. The display panel according to claim 4, wherein a fourth one of the bus bars provides a common return rail.

7. The display device according to claim 1, wherein the or each bus bar has a plurality of holes and each PCB has a plurality of corresponding through holes, and the bus bar is physically connected to the PCBs by members passing through the through holes in the PCBs and into the corresponding holes in the or each bus bar.

8. The display panel according to claim 7, wherein the or each bus bar is also electrically connected to the PCBs by the members.

9. The display panel according to claim 1 wherein the plurality of display PCBs are arranged into a first group and a second group, each group containing a plurality of display PCBs, and the display panel comprising a first group of bus bars and a second group of bus bars, each group of bus bars comprising four parallel bus bars, wherein: each display PCB bears a first set of light sources adapted to emit light of a first colour and a second set of light sources adapted to emit light of a second colour; the first set of light sources of each display PCB in the first group of PCBs being electrically coupled to a first one of the bus bars of the first group of bus bars which is supplied with power at a first voltage, and the second set of light sources being electrically coupled to a second one of the bus bars of the first group of bus bars which is supplied with power at a second voltage, each display PCB in the first group of PCBs bears control circuits, the control circuits being electrically coupled to a third one of the bus bars of the first group of bus bars which is supplied with power at a third voltage, and a fourth one of the bus bars of the first group of bus bars provides a common return rail for each display PCB in the first group of PCBs; and the first set of light sources of each display PCB in the second group of PCBs being electrically coupled to a first one of the bus bars of the second group of bus bars which is supplied with power at a first voltage, and the second set of light sources being electrically coupled to a second one of the bus bars of the second group of bus bars which is supplied with power at a second voltage, each display PCB in the second group of PCBs bears control circuits, the control circuits being electrically coupled to a third one of the bus bars of the second group of bus bars which is supplied with power at a third voltage, and a fourth one of the bus bars of the second group of bus bars provides a common return rail for each display PCB in the second group of PCBs.

10. The display panel according to claim 9, wherein the first and second groups of bus bars are parallel and adjacent to one another and the first and second groups of display PCBs extend in opposite directions away from the bus bars.

11. The display panel according to claim 1, wherein each light source is a surface mount light emitting diode ‘LED’.

12. The display panel according to claim 11, wherein each LED has a cover comprising at least one side wall and an end wall which together define a recess for receiving and engaging the LED in use, the cover further comprising an aperture within the end wall and a registration feature adapted to ensure that the aperture aligns with a light emitting portion of the LED in use, wherein the surface characteristics of the cover are such that substantially all incident visible light impinging on the cover is absorbed thereby providing an enhanced contrast ratio with respect to light emitted by the LED in use.

13. The display panel according to claim 12, wherein the cover is black in colour.

14. The display panel according to claim 12, wherein the surface area of the aperture is smaller than the surface area of the surface of the LED containing the light emitting portion.

15. The display panel according to claim 12, wherein the aperture is at the centre of a depressed portion in the cover.

16. The display panel according to claim 15, wherein the depressed portion is bevelled.

17. The display panel according to claim 12, wherein the registration feature comprises a set of ribs within the recess which interdigitate with mounting legs on the LED when the cover is placed over the LED in use.

18. The display panel according to claim 12, comprising two opposing walls spaced apart such that they make an interference fit with the LED when the cover is placed over the LED in use.

19. The display panel according to claim 12, wherein the PCBs are black.

20. The display panel according to claim 12, wherein the LEDs do not have lenses.

21. The display panel according to claim 1, wherein the display panel comprises a casing.

22. The display panel according to claim 1, wherein the casing comprises an openable lid.

23. The display panel according to claim 1, wherein the panel is mounted on a vehicle.

24. The display panel according to claim 23, wherein the vehicle is a bus.

25. The display panel according to claim 23, wherein the display panel is cooled using cooling air taken from inside the vehicle.

26. A kit of parts suitable for constructing a display panel according to claim 1.

27. A method of operating a display panel comprising a plurality of light sources, the method comprising: sensing an ambient light level; and setting the brightness of the light sources to provide a desired contrast value based upon the sensed ambient light level; wherein the rate of change of the brightness of the light sources has a predetermined maximum value.

28. The method according to claim 27, wherein the predetermined maximum value of rate of change of brightness is 1% of the maximum brightness per second.

29. The method according to claim 27, wherein the brightness is set based upon a rolling average of sensed ambient light level.

30. The method according to claim 29, wherein the brightness is set based upon a rolling average of 30 sensed ambient light levels.

31. The method according to claim 30, wherein the ambient light level is sensed once a second.

32. The method according to claim 27, wherein the brightness is set to a lower value than required to provide said desired contrast value in response to detecting overheating of a part of the display panel.

33. The method according to claim 27, wherein the display panel is attached to a vehicle and the brightness is set to a lower value than required to provide said desired contrast value in response to detecting a low voltage level in a battery of the vehicle.

34. The display panel according to claim 1, further comprising a control means adapted to cause the display panel to carry out the method of operating a display panel comprising a plurality of light sources, the method comprising: sensing an ambient light level; and setting the brightness of the light sources to provide a desired contrast value based upon the sensed ambient light level; wherein the rate of change of the brightness of the light sources has a predetermined maximum value.

35. (canceled)
